(19) United States
(12) Patent Application Publication
(10) Pub. No.: US 2003/0061679 A1
(43) Pub. Date: Apr. 3, 2003

(54) Bushing assembly having a self-alignment function

(76) Inventors: Martin Chang, Hsin Chu (TW); Clark Cheng, Hsin Chu (TW)

Correspondence Address: CHARLES E. BAXLEY, ESQUIRE, Hart, Baxley, Daniels & Holton, 59 John St. 5 Fl, New York, NY, 10038, US

(21) Appl. No.: 10/191,866

(22) Filed: Jul. 10, 2002

(30) Foreign Application Priority Data
Oct. 2, 2001 (TW) 090216716

(51) Int. Cl. F16L 5/00

(52) U.S. Cl. 16/2.1

(57) ABSTRACT

A bushing assembly having a self-alignment function includes inner bushings mounted in outer bushings. A center adjustment unit is mounted between the outer bushing and the inner bushing, and includes convex arcuate faces mating with concave arcuate faces. Thus, the inner bushing may micro-adjust an assembly angle automatically, to maintain at the same axis with other inner bushing, thereby facilitating passage and mounting of a shaft. In addition, the outer bushing or the inner bushing is formed with a slit, or the outer bushing may be made detachable, so that the outer bushing and the inner bushing may be combined easily.

### BACKGROUND OF THE INVENTION

1. Field of the Invention

The present invention relates to a bushing assembly having a self-alignment function, which may be mounted on a chassis (optical module) of an image input/output device, so that the inner bushing may be adjusted an assembly angle, and the outer bushing and the inner bushing may be combined easily.

2. Description of the Related Art

An image capture device, such as a scanner, is provided with a chassis for scanning and receiving images.

At least one side of the chassis is provided with two opposite outer bushings located at the same axis, and an inner bushing is mounted in each outer bushing. A shaft passes through the inner bushings in the outer bushings. Thus, the chassis may combine with the shaft, and the chassis may move along the axial direction of the shaft reciprocally.

Recently, the inner bushing is made by a sintered copper alloy, and contains impregnated lubricating oil. The housing of the chassis is made of plastic. Thus, the inner bushing may combine with the outer bushing by two methods. One is to place the inner bushing in the mold to integrally combine with the chassis by an injection molding process. The other is to use a tool to press the inner bushing into the outer bushing after the chassis is formed by an injection molding process.

However, in the first method, the required period is longer, and the impregnated lubricating oil may transude on the surface of the inner bushing during the molding process. In the second method, the fabrication tolerance of the inner bushing and the assembly tolerance between the outer bushings are too large, so that the tightness cannot be controlled easily, and the inner bushing is easily loosened or the outer bushing is easily broken.

Thus, the fabrication consumes much time and the assembly is inconvenient. In addition, the inner bushings easily tilt due to the tolerance of fabrication and assembly. Thus, even the shaft passes through the tilt inner bushings, the chassis cannot move conveniently. If the inner bushings tilt too much, the chassis cannot combine with the shaft.

Next, the inner bushing is fixed in the outer bushing by the friction of the side wall. Thus, the values of the pulling and pushing forces will be different due to the diameter size. The designer has to continuously measure and test, so that the inner bushing may be exactly positioned in the outer bushing when the chassis is moved relative to the shaft.

### SUMMARY OF THE INVENTION

The primary objective of the present invention is to provide a bushing assembly having a self-alignment function, wherein the inner bushing mounted in the outer bushing and may be micro-adjusted an angle, so that the opposite inner bushings may maintain at the same axis, thereby facilitating passage and mounting of a shaft.

Another objective of the present invention is to provide a bushing assembly having a self-alignment function, wherein the inner bushing and the outer bushing may be combined easily.

In accordance with the present invention, there is provided a bushing assembly having a self-alignment function, comprising:

at least two outer bushings, each axially formed with a shaft hole, each shaft hole being opposite to each other, and each outer bushing having an inner wall face;

at least two inner bushings, each respectively mounted in the shaft hole of the outer bushing, and each inner bushing having an outer wall face; and

at least two sets of center adjustment units, each respectively mounted on the outer wall face of the inner bushing and the inner wall face of the outer bushing, by combination of convex arcuate faces and concave arcuate faces, each inner bushing producing capacity of micro-adjusting an assembly angle, to maintain at the same axis.

Thus, a shaft may conveniently pass through the mating outer bushing, and the relative movement between the shaft and the chassis is convenient.

In addition, the outer bushing or the inner bushing is formed with a slit, or the outer bushing may be made detachable, so that the outer bushing and the inner bushing may be combined easily.

Further benefits and advantages of the present invention will become apparent after a careful reading of the detailed description with appropriate reference to the accompanying drawings.

### BRIEF DESCRIPTION OF THE DRAWINGS

FIG. 1 is a pictorial view of a bushing assembly having a self-alignment function in accordance with the present invention;

FIG. 2 is a pictorial view of a structure of an inner bushing and an outer bushing in accordance with one embodiment of the present invention;

FIG. 3 is an end view of a structure of an inner bushing and an outer bushing in accordance with one embodiment of the present invention;

FIG. 4 is a schematic view of an assembly structure of a shaft, an inner bushing and an outer bushing in accordance with one embodiment of the present invention;

FIG. 5 is a pictorial view of a structure of an inner bushing and an outer bushing in accordance with another embodiment of the present invention;

FIG. 6 is a pictorial view of a structure of an inner bushing and an outer bushing in accordance with another embodiment of the present invention;

FIG. 7 is a pictorial view of a structure of an inner bushing and an outer bushing in accordance with another embodiment of the present invention;

FIG. 8 is a cross-sectional assembly view of FIG. 7;

FIG. 9 is a pictorial view of a structure of an inner bushing and an outer bushing in accordance with another embodiment of the present invention;

FIG. 10 is a pictorial view of a structure of an inner bushing and an outer bushing in accordance with another embodiment of the present invention;

FIG. 11 is a cross-sectional side view of an assembly structure of a shaft, an inner bushing and an outer bushing of the present invention;

FIG. 12 is a cross-sectional view of an oil storage structure between an inner bushing and an outer bushing in accordance with one embodiment of the present invention;

FIG. 12 is a cross-sectional view of an oil storage structure between an inner bushing and an outer bushing in accordance with one embodiment of the present invention;

FIG. 13 is a cross-sectional view of an oil storage structure between an inner bushing and an outer bushing in accordance with another embodiment of the present invention;

FIG. 14 is a cross-sectional view of a low contact area structure of an inner bushing and an outer bushing in accordance with one embodiment of the present invention; and

FIG. 15 is a cross-sectional view of a low contact area structure of an inner bushing and an outer bushing in accordance with another embodiment of the present invention.

### DETAILED DESCRIPTION OF THE PREFERRED EMBODIMENTS OF THE INVENTION

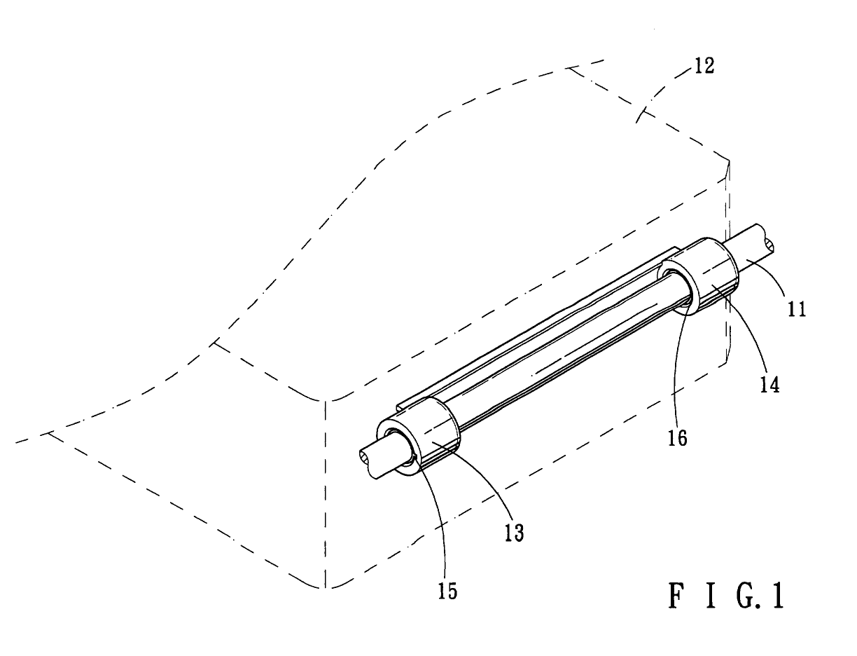

FIG. 1 shows an assembly of a shaft and a chassis. The chassis 12 has one side provided with two opposite outer bushings 13 and 14, and two inner bushings 15 and 16 mounted in the two opposite outer bushings 13 and 14. The shaft 11 is extended through the two inner bushings 15 and 16 to combine with the chassis 12. The chassis 12 may move in the axial direction of the shaft 11 reciprocally.

The two outer bushings 13 and 14 have the same structure, and the two inner bushings 15 and 16 also have the same structure. Thus, just only an assembly of one outer bushing 13 and one inner bushing 15 are described as follows.

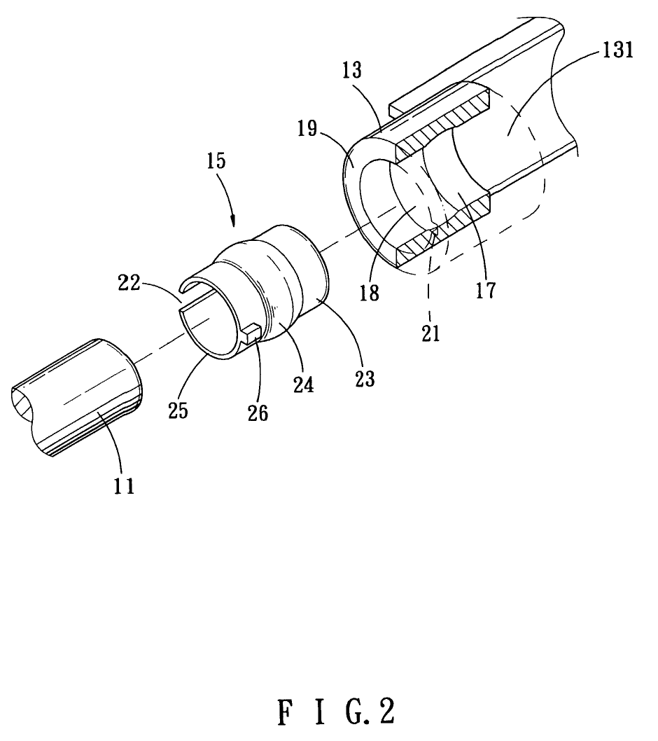

FIG. 2 shows a combination of an inner bushing and an outer bushing in accordance with one embodiment of the present invention. The outer bushing 13 is axially formed with a shaft hole 131 which has an inner wall face 17 formed with an annular concave arcuate face (annular groove) 18. The inner wall face 17 of the shaft hole 131 of the outer bushing 13 is formed with a spline 21. The spline 21 is located adjacent to an end edge 19.

The inner bushing 15 is hollow, and has a surface axially formed with a slit 22. The slit 22 may be linear (straight line or oblique line) or a helical curve. The outer wall face 23 of the inner bushing 15 is protruded with an annular convex arcuate face 24, and formed with a protruding key 26 located adjacent to an end edge 25.

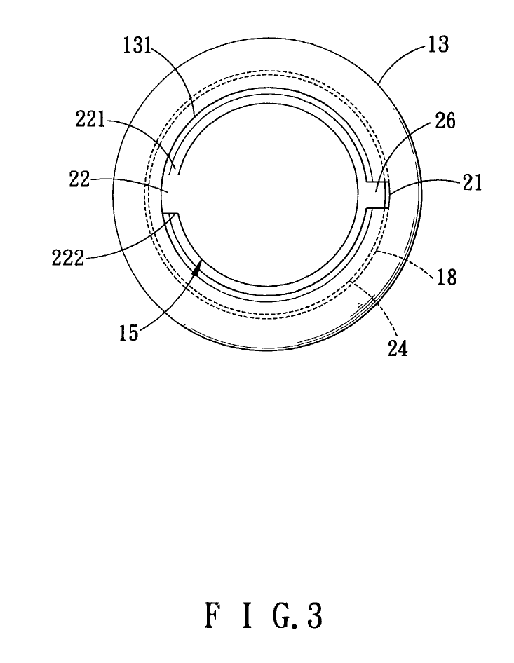

FIG. 3 shows an end view of the combination of an inner bushing and an outer bushing. When the inner bushing 15 is combined with the outer bushing 13, the two side portions 221 and 222 of the slit 22 of the inner bushing 15 are pressed together, to shorten the outer diameter of the inner bushing 15. Then, the inner bushing 15 having a shortened outer diameter is fitted into the shaft hole 131 of the outer bushing 13, so that the protruding key 26 may be locked in the spline 21, and the annular convex arcuate face 24 may align with the concave arcuate face 18. When the compressing force applied on the inner bushing 15 is released, the outer diameter of the inner bushing 15 may be expanded by the elastic restoring force. Thus, the convex arcuate face 24 may be locked with the concave arcuate face 18, so that the inner bushing 15 may be combined with the outer bushing 13.

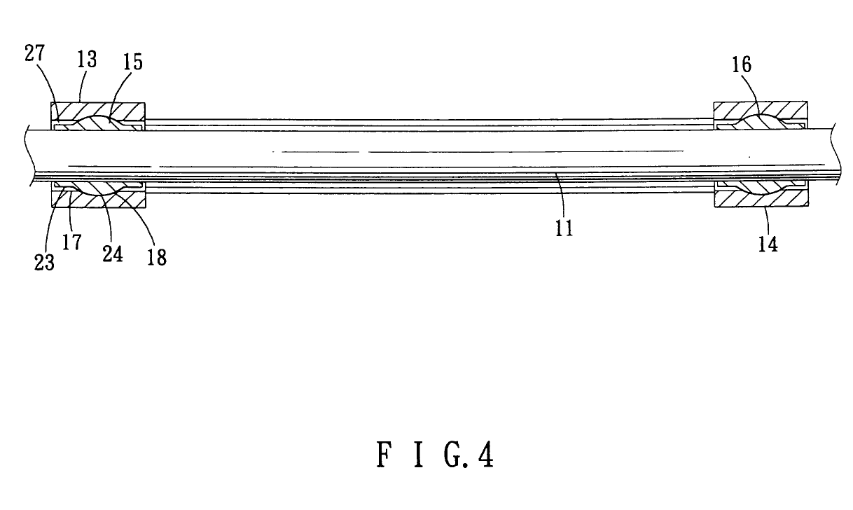

FIG. 4 shows a schematic view of the shaft and the combination of an inner bushing and an outer bushing. When the inner bushing 15 is combined with the outer bushing 13, a distance 27 is formed between the outer wall face 23 and the mating inner wall face 17. The distance 27 may mate with the combination of the convex arcuate face 24 and the concave arcuate face 18, so that the inner bushing 15 may be micro-adjusted the assembly angle in the outer bushing 13. Similarly, the inner bushing 16 may be micro-adjusted the assembly angle in the outer bushing 14. Thus, the two mating inner bushings 15 and 16 may be exactly maintained at the same axis. In other word, when the shaft 11 is passed through the two mating inner bushings 15 and 16, the two mating inner bushings 15 and 16 may adjust the assembly angle automatically, so that the shaft 11 may be passed through the two mating inner bushings 15 and 16 conveniently.

It is appreciated that, the material of the two mating inner bushings 15 and 16 includes plastic, rubber or composite of plastic and rubber.

The two mating inner bushings 15 and 16 may be micro-adjusted the assembly angle so that the two mating inner bushings 15 and 16 may be located at the same axis. Thus, a “center adjustment unit” may be defined as a structure that may make the two mating inner bushings 15 and 16 to be micro-adjusted the assembly angle. The “center adjustment unit” includes the combination of the convex arcuate face 24 and the concave arcuate face 18, and may include an equivalent structure.

Thus, the combination of the two mating inner bushings 15 and 16 and the two mating outer bushings 13 and 14 capable of adjusting the assembly angle may solve the drawback of the assembly inconvenience due to the tolerance of fabrication.

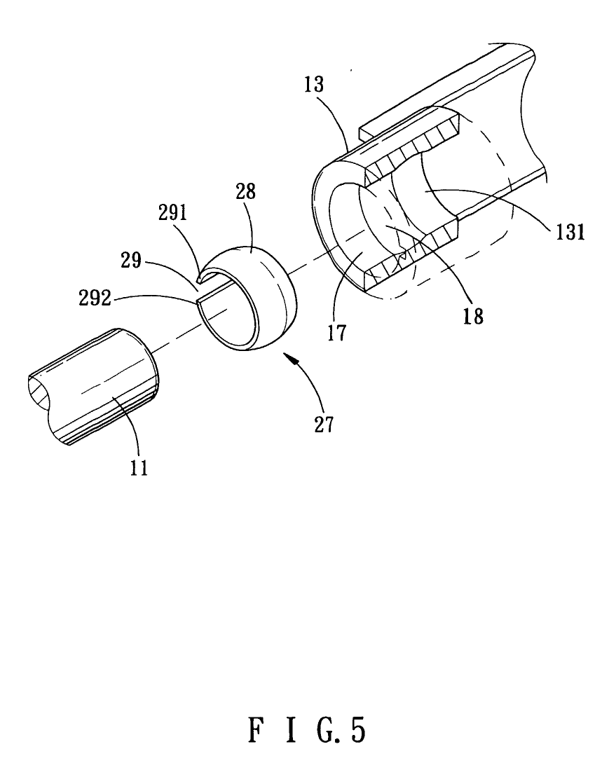

FIG. 5 shows a combination of an inner bushing and an outer bushing in accordance with another embodiment of the present invention. The inner bushing 27 is made spherical to form a convex arcuate face 28, and has a surface axially formed with a slit 29. The slit 29 may be linear (straight line or oblique line) or a helical curve. The outer bushing 13 is axially formed with a shaft hole 131 which has an inner wall face 17 formed with an annular concave arcuate face 18.

Thus, the two side portions 291 and 292 of the slit 29 may be pressed toward each other to shorten the outer diameter of the inner bushing 27, thereby facilitating the inner bushing 27 being fitted into the shaft hole 131. The convex arcuate face 28 may be locked in the concave arcuate face 18, so that the inner bushing 27 may be adjusted the assembly angle movably, thereby facilitating passage of the shaft 11.

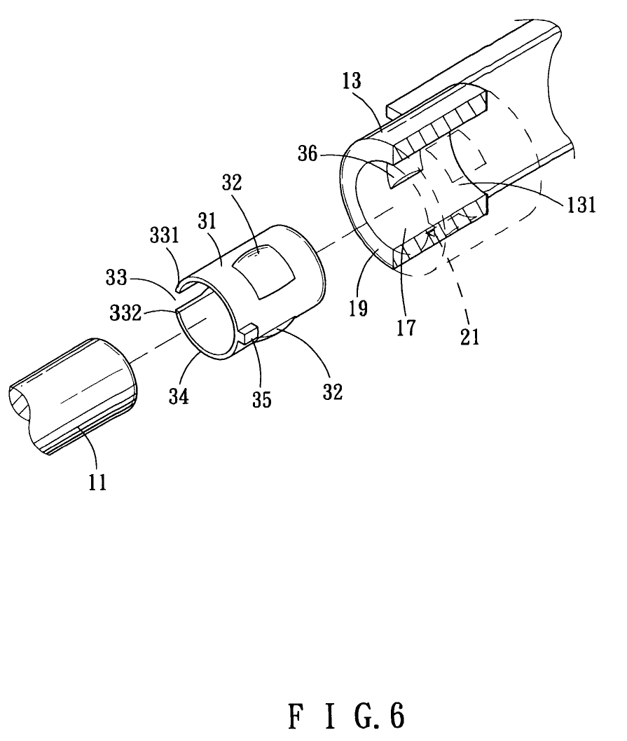

FIG. 6 shows a combination of an inner bushing and an outer bushing in accordance with another embodiment of the present invention. The outer surface of the inner bushing 31 is formed with multiple protruded convex arcuate faces 32, is axially formed with a slit 33, and is protruded with a protruding key 35 located adjacent to the end edge 34. The slit 33 may be linear (straight line or oblique line) or a helical curve. The outer bushing 13 is axially formed with a shaft hole 131 which has an inner wall face 17 formed with multiple concave arcuate faces 36, and provided with a spline 21 located adjacent to the end edge 19.

Thus, the two side portions 331 and 332 of the slit 33 may be pressed toward each other to shorten the outer diameter of the inner bushing 31, thereby facilitating the inner bushing 31 being fitted into the shaft hole 131. The convex arcuate faces 32 may be respectively locked in the concave arcuate face 36, and the protruding key 35 may be mounted in the spline 21, so that the inner bushing 31 may be-adjusted the assembly angle movably, thereby facilitating passage of the shaft 11.

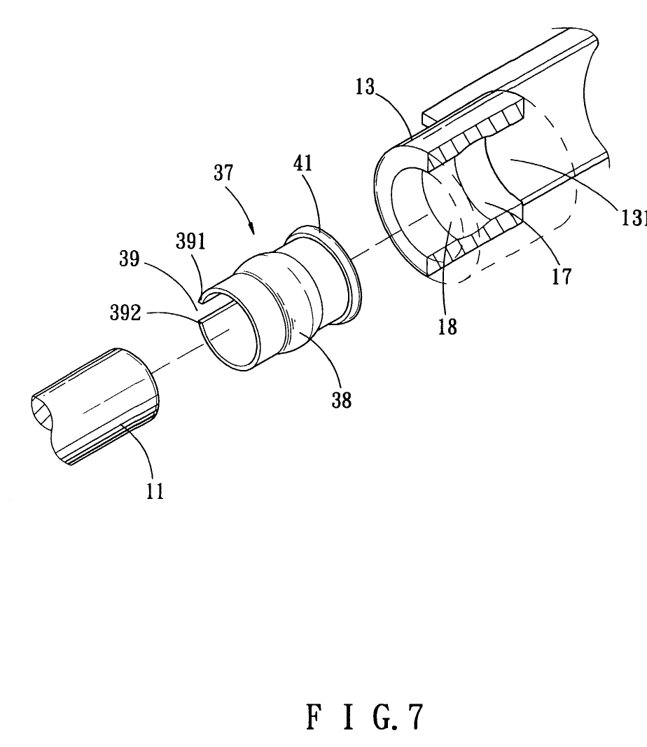

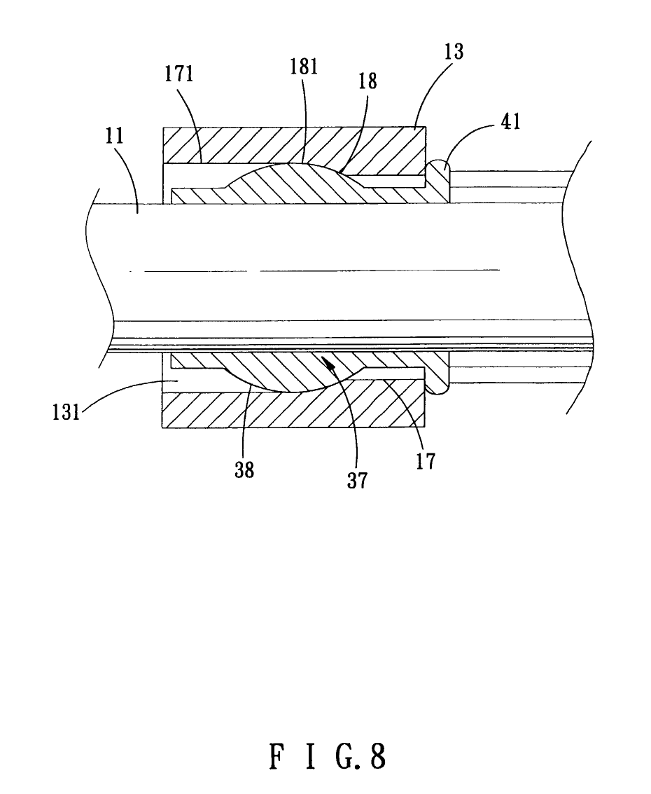

FIGS. 7 and 8 show a combination of an inner bushing and an outer bushing in accordance with another embodiment of the present invention. The outer surface of the inner bushing 37 is formed with an annular convex arcuate face 38, and axially formed with a slit 39. One end of the inner bushing 37 has a peripheral face protruded with a flange 41. The outer bushing 13 is axially formed with a shaft hole 131. The inner wall face 17 of the shaft hole 131 is formed with an annular concave arcuate face 18. It is appreciated that, the inner wall face 171 on one side of the concave arcuate face 18 is tangent to the top point 181 of the concave arcuate face 18 as shown in FIG. 8.

Thus, the two side portions 391 and 392 of the slit 39 may be pressed toward each other to shorten the outer diameter of the inner bushing 37, thereby facilitating the inner bushing 37 being fitted into the shaft hole 131. The flange 41 of the inner bushing 37 is rested on one end of the outer bushing 13, wherein the one end is distal to the inner wall face 171. The convex arcuate face 38 may be locked in the concave arcuate face 18, so that the inner bushing 37 may be adjusted the assembly angle movably, thereby facilitating passage of the shaft 11.

According to the above embodiments, the inner bushings 15, 27, 31 and 37 may be formed with slits 22, 29, 33 and 39, so that the inner bushings 15, 27, 31 and 37 may be combined with the outer bushing 13. The convex arcuate faces 24, 28, 32 and 38 may be combined with the concave arcuate faces 18 and 36, so that the inner bushings 15, 27, 31 and 37 may be adjusted the assembly angle. Other structures may make the inner bushing combine with the outer bushing easily.

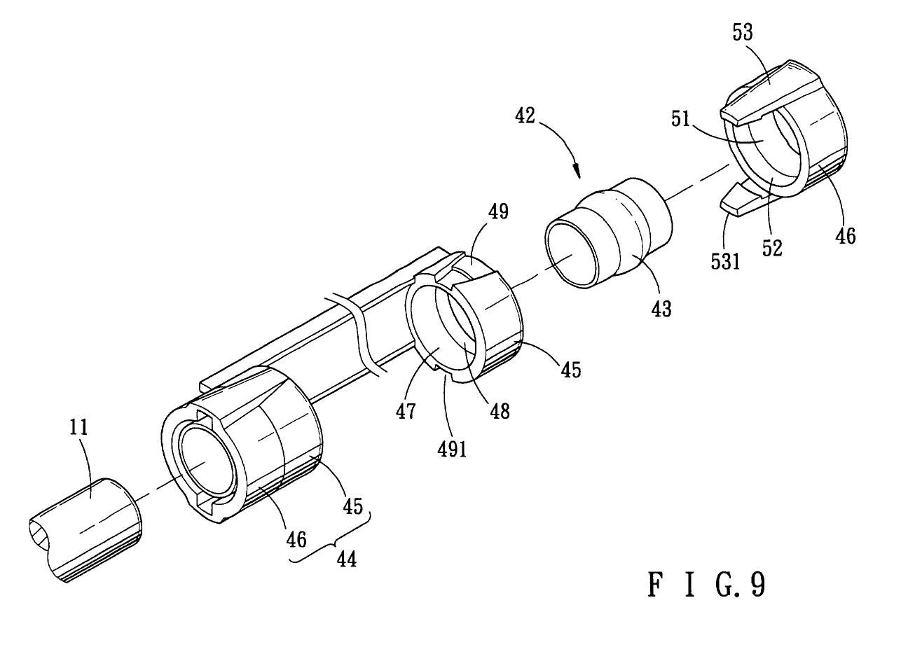

FIG. 9 shows a combination of an inner bushing and an outer bushing in accordance with another embodiment of the present invention. The inner bushing 42 is a hollow ring without the slit. The outer surface of the inner bushing 42 is formed with an annular convex arcuate face 43. The outer bushing 44 is made detachable, and includes a fixed first body 45 and a movable second body 46. The outer bushing 44 is axially provided with the first body 45 and the second body 46.

The first body 45 is a ring body, and has an inner wall face 47 having one end formed with a semi-concave arcuate face 48. The outer surface of the first body 45 is formed with two opposite locking grooves 49 and 491 with an included angle of 180 degrees therebetween. The second body 46 is a ring body, and has an inner wall face 51 having one end formed with a semi-concave arcuate face 52. The outer surface of the second body 46 is formed with two opposite locking hooks 53 and 531 with an included angle of 180 degrees therebetween.

In assembly, the inner bushing 42 is initially assembled with the first body 45, and the second body 46 is then mounted on the inner bushing 42. The two opposite locking hooks 53 and 531 are respectively locked in the two opposite locking grooves 49 and 491. Thus, the inner bushing 42 may be assembled with the first body 45 and the second body 46. The semi-concave arcuate face 48 of the first body 45 and the semi-concave arcuate face 52 of the second body 46 may be combined with the convex arcuate face 43 of the inner bushing 42. Thus, the outer bushing 44 may be combined with the inner bushing 42 easily. The inner bushing 42 may be adjusted the assembly angle, thereby facilitating passage of the shaft 11. Similarly, the inner bushing 42 may initially combine with the second body 46.

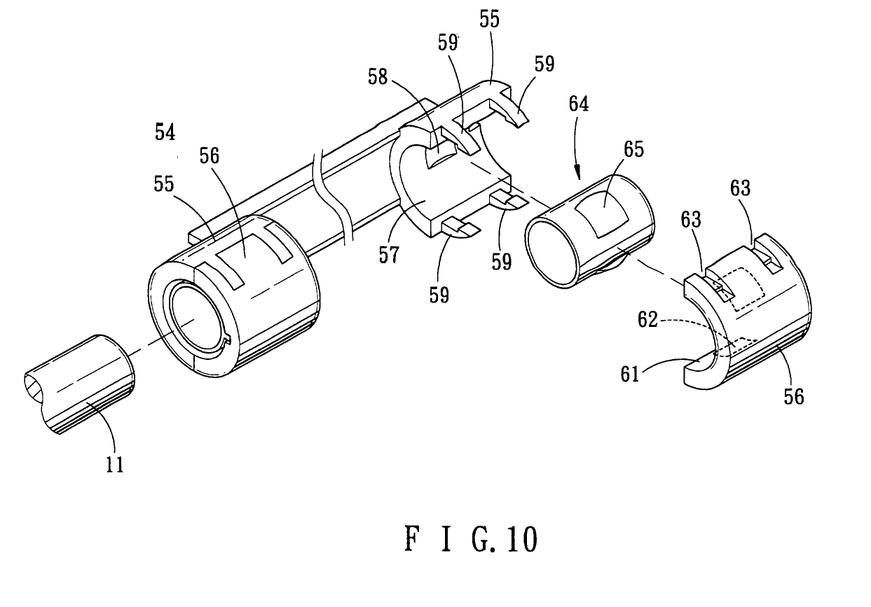

FIG. 10 shows a structure, wherein the outer bushing is detachable. The inner bushing 64 is a hollow ring. The outer surface of the inner bushing 64 is formed with multiple convex arcuate faces 65. The outer bushing 54 is axially provided with a fixed first body 55 and a movable second body 56.

The first body 55 has an inner wall face 57 formed with multiple concave arcuate faces 58. The outer surface of the first body 55 is provided with multiple locking hooks 59 each extended along the curvature of the outer surface of the first body 55. The second body 56 has an inner wall face 61 formed with multiple concave arcuate faces 62. The outer surface of the second body 56 is provided with multiple locking grooves 63.

In assembly, the inner bushing 64 is placed between the first body 55 and the second body 56, and the convex arcuate faces 65 respectively align with the concave arcuate faces 58 and 62. The second body 56 is mounted on the first body 55, and the locking hooks 59 are locked in the locking grooves 63, so that the inner bushing 64, the first body 55 and the second body 56 may be combined together. The convex arcuate faces 65 may align with the concave arcuate faces 58 and 62, so that the inner bushing 64 may adjust the assembly angle automatically, thereby facilitating passage of the shaft 11.

According to the above embodiments, the inner bushing may be combined with the outer bushing easily by adjusting the outer diameter of the inner bushing or by making the outer bushing detachable. FIG. 11 shows an equivalent structure. The outer bushing 13 is axially formed with a slit 66, so that the outer bushing 13 may be expanded elastically. Thus, when a ring-shaped inner bushing 67 is combined with the outer bushing 13, the inner bushing 67 may be forced into the shaft hole 131 of the outer bushing 13 by the elastic expanding capacity of the outer bushing 13. After the shaft 11 is combined with the chassis (not shown), the chassis is downward due to the gravity, so that the inner bushing 67 is pressed on the shaft 11. Thus, the slit 66 is optimally located at the bottom of the outer bushing 13.

The inner bushings 15, 27, 31, 37 and 67 are made of plastic, rubber or composite of plastic and rubber, and contain no impregnated lubricating oil. Thus, the lubricating oil needs to be stored between the inner bushings 15, 27, 31, 37 and 67 and the outer bushings 13, 44 and 54. The following description takes the inner bushing 31 and the outer bushing 13 for example.

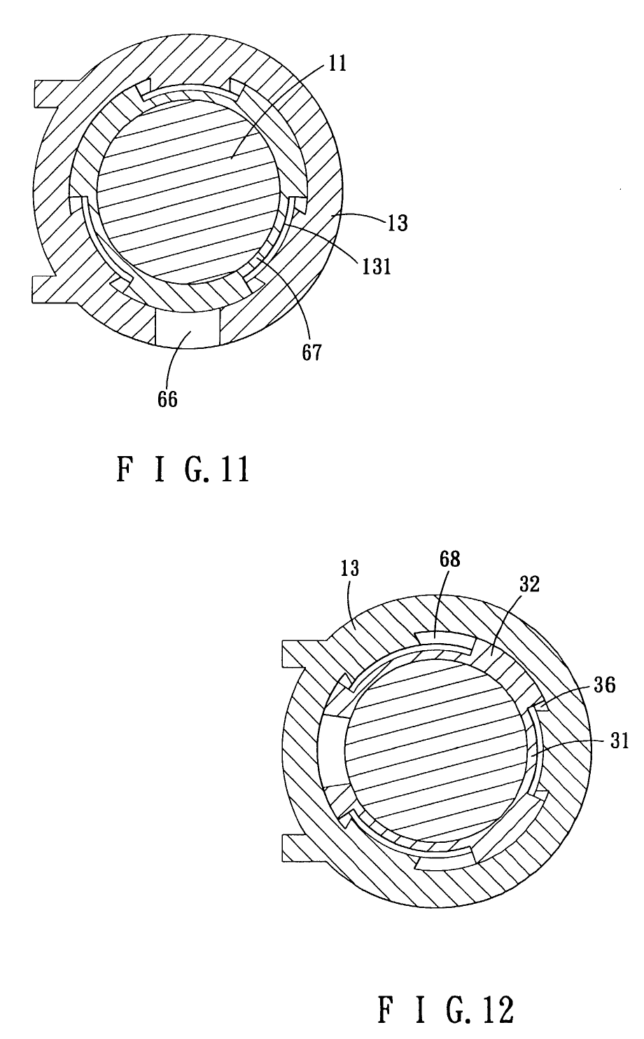

FIG. 12 shows an oil storage structure in accordance with one embodiment of the present invention. When the inner bushing 31 and the outer bushing 13 are combined, the convex arcuate face 32 of the inner bushing 31 is assembled in the concave arcuate face 36 of the outer bushing 13. The inner bushing 31 may adjust the assembly angle automatically, so that a gap is formed between the convex arcuate face 32 of the inner bushing 31 and the concave arcuate face 36 of the outer bushing 13. The gap may form an oil storage space 68 for storing the lubricating oil, thereby providing a good lubricating effect when inner bushing 31 adjusts the assembly angle automatically.

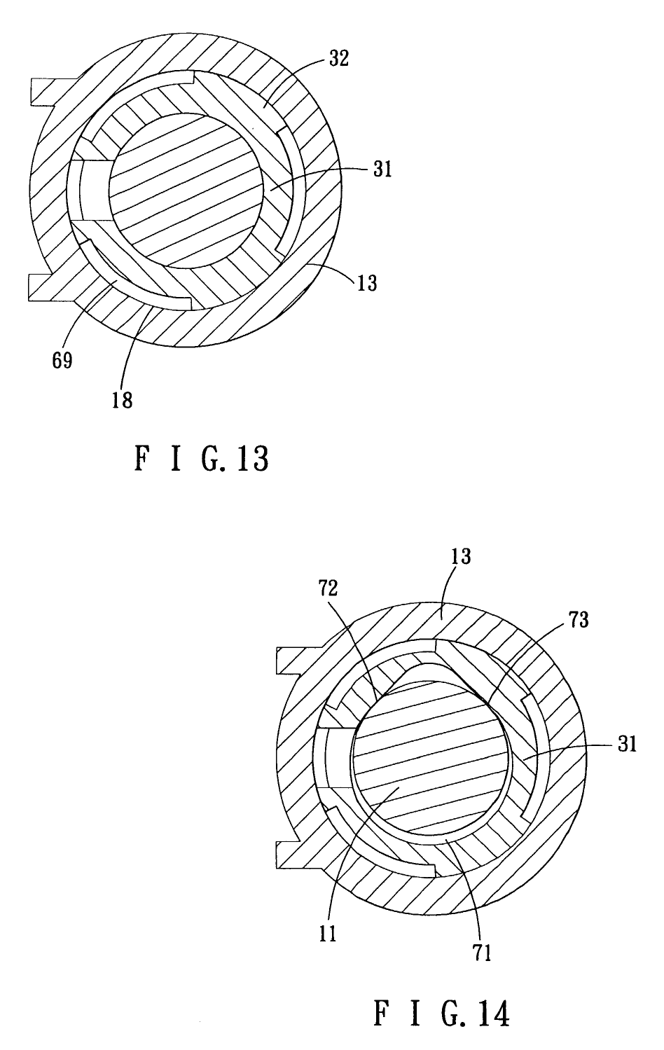

FIG. 13 shows an oil storage structure in accordance with another embodiment of the present invention. When the inner bushing 31 and the outer bushing 13 are combined, the convex arcuate face 32 of the inner bushing 31 is assembled in the annular concave arcuate face 18 of the outer bushing 13. Thus, a gap is formed between the annular concave arcuate face 18 of the outer bushing 13 and the outer surface of the inner bushing 31. The gap may form an oil storage space 69 for storing the lubricating oil, thereby providing a good lubricating effect when the inner bushing 31 adjusts the assembly angle automatically.

Any combination of the inner bushings 15, 27, 31, 37 and 67 and the outer bushings 13, 44 and 54 has to move along the shaft 11, so that the outer diameter of the shaft 11 may be close to the inner diameter of each of the inner bushings 15, 27, 31, 37 and 67. Thus, the shaft 11 may be closely rested on each of the inner bushings 15, 27, 31, 37 and 67. In addition, the shaft 11 and each of the inner bushings 15, 27, 31, 37 and 67 may have a larger contact area, without affecting convenience of the relative movement therebetween.

FIG. 14 shows a combination of a shaft and an inner bushing in accordance with one embodiment of the present invention. The wall face of the shaft hole 71 of the inner bushing 31 is formed with two opposite linear plane portions 72 and 73. When the shaft 11 is mounted in the shaft hole 71 of the inner bushing 31, the outer surface of the shaft 11 is tangent to the two linear plane portions 72 and 73. After the shaft 11 is combined with the chassis (not shown), the chassis is downward due to the gravity, so that the inner bushing 31 is pressed on the shaft 11. Thus, the two linear plane portions 72 and 73 are tangent to the two upper side faces, thereby forming the optimal mounting state, so as to reduce the contact area between the shaft 11 and the inner bushing 31.

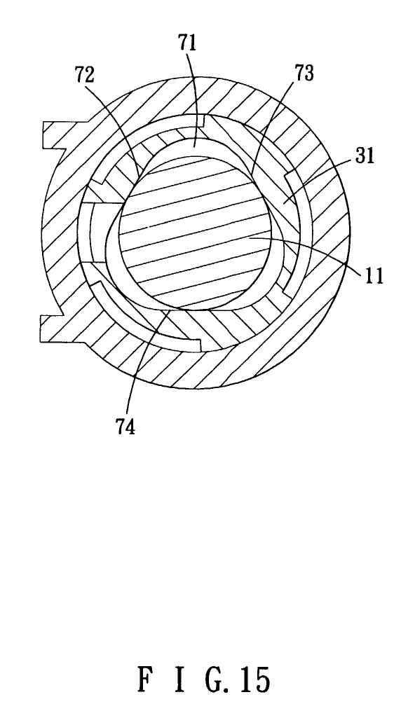

FIG. 15 shows a combination of a shaft and an inner bushing in accordance with another embodiment of the present invention. The wall face of the shaft hole 71 of the inner bushing 31 is formed with three opposite linear plane portions 72, 73 and 74. When the shaft 11 is mounted in the shaft hole 71 of the inner bushing 31, the outer surface of the shaft 11 is tangent to the three linear plane portions 72, 73 and 74, thereby achieving the purpose of reducing the contact area of the shaft 11 and the inner bushing 31.

Thus, in accordance with the above-mentioned embodiments of the present invention, the inner bushing of the present invention may adjust the assembly angle automatically, and may be combined with the outer bushing easily. In addition, the gap between the outer bushing and the inner bushing may form an oil storage space for storing the lubricating oil. Further, the shaft hole of the inner bushing may be designed to reduce the contact area of the II shaft and the inner bushing.

While the preferred embodiments of the present invention have been shown and described, it will be apparent to those skilled in the art that various modifications may be made in the embodiments without departing from the spirit of the present invention. Such modifications are all within the scope of the present invention.

What is claimed is:

1. A bushing assembly having a self-alignment function, comprising:
at least two outer bushings, each axially formed with a shaft hole, each shaft hole being opposite to each other, and each outer bushing having an inner wall face;
at least two inner bushings, each respectively mounted in the shaft hole of the outer bushing, and each inner bushing having an outer wall face; and
at least two sets of center adjustment units, each respectively mounted on the outer wall face of the inner bushing and the inner wall face of the outer bushing, by combination of convex arcuate faces and concave arcuate faces, each inner bushing producing capacity of micro-adjusting an assembly angle, to maintain at the same axis.

2. The bushing assembly having a self-alignment function in accordance with claim 1, wherein the convex arcuate face of the center adjustment unit is formed on the outer wall face of the inner bushing, and the concave arcuate face of the center adjustment unit is formed on the inner wall face of the outer bushing.

3. The bushing assembly having a self-alignment function in accordance with claim 1, wherein each outer bushing is secured on a chassis.

4. The bushing assembly having a self-alignment function in accordance with claim 1, wherein the convex arcuate face of the center adjustment unit is ring-shaped.

5. The bushing assembly having a self-alignment function in accordance with claim 1, wherein the convex arcuate face of the center adjustment unit is formed with multiple convex faces.

6. The bushing assembly having a self-alignment function in accordance with claim 1, wherein the concave arcuate face of the center adjustment unit is ring-shaped.

7. The bushing assembly having a self-alignment function in accordance with claim 1, wherein the concave arcuate face of the center adjustment unit is formed with multiple concave faces.

8. The bushing assembly having a self-alignment function in accordance with claim 1, wherein the inner bushing has a surface axially formed with a slit.

9. The bushing assembly having a self-alignment function in accordance with claim 8, wherein the slit has a straight line shape.

10. The bushing assembly having a self-alignment function in accordance with claim 8, wherein the slit has a curve shape.

11. The bushing assembly having a self-alignment function in accordance with claim 1, wherein the outer bushing includes a first body and a second body combined with each other.

12. The bushing assembly having a self-alignment function in accordance with claim 11, wherein the first body and the second body of the outer bushing are radially combined with each other.

13. The bushing assembly having a self-alignment function in accordance with claim 11, wherein the first body and the second body of the outer bushing are axially combined with each other.

14. The bushing assembly having a self-alignment function in accordance with claim 1, wherein the surface of the inner bushing is provided with protruding keys, and the inner wall face of the outer bushing is provided with splines for mounting the protruding keys of the inner bushing.

15. The bushing assembly having a self-alignment function in accordance with claim 1, wherein the inner bushing has one end provided with a flange.

16. The bushing assembly having a self-alignment function in accordance with claim 1, wherein the shaft hole of the outer bushing has an inner wall face formed with an annular concave arcuate face, and the inner wall face at one side of the concave arcuate face is tangent to the top point of the concave arcuate face.

17. The bushing assembly having a self-alignment function in accordance with claim 1, wherein the axial shaft hole of the inner bushing has a circular shape.

18. The bushing assembly having a self-alignment function in accordance with claim 1, wherein the axial shaft hole of the inner bushing has a wall face formed with at least two linear plane portions.

19. The bushing assembly having a self-alignment function in accordance with claim 1, wherein an oil storage space is formed between the inner wall face of the outer bushing and the outer wall face of the inner bushing.

20. The bushing assembly having a self-alignment function in accordance with claim 1, wherein the outer bushing has a bottom formed with a slit.
